(19) United States
(12) Patent Application Publication
(10) Pub. No.: US 2024/0371180 A1
(43) Pub. Date: Nov. 7, 2024

(54) Device and Method for Determining an Intention of a Driver to Turn

(71) Applicant: Bayerische Motoren Werke Aktiengesellschaft, Muenchen (DE)

(72) Inventor: Dorin AITEANU, Berg (DE)

(21) Appl. No.: 18/652,096

(22) Filed: May 1, 2024

(30) Foreign Application Priority Data
May 2, 2023 (DE) 10 2023 111 205.8

(51) Int. Cl. G06V 20/59; B60Q 1/34; G06V 20/56

(52) U.S. Cl. CPC G06V 20/597; B60Q 1/346; G06V 20/56

(57) ABSTRACT

A device and a method determine an intention of a driver to turn. A sequence of images of an area of the vehicle interior is captured and processed to determine a focus area of a driver outside the vehicle. The odometry data is processed to determine the possibility of the vehicle turning towards the determined focus area. The environmental data is processed to determine whether odometry data that enables turning has another cause. The intention to turn is determined based on the results of processing the image data, the odometry data and the environmental data.

### CROSS REFERENCE TO RELATED APPLICATION

This application claims priority under 35 U.S.C. § 119 from German Patent Application No. 10 2023 111 205.8, filed May 2, 2023, the entire disclosure of which is herein expressly incorporated by reference.

### BACKGROUND AND SUMMARY

In a device and a method for determining an intention of a driver to turn, a camera of the vehicle arranged in the interior of the vehicle is used to capture at least one image sequence of images, each image depicting an area of the interior, and to generate image data corresponding to each image, which are processed.

Document DE 10 2016 220 518 A1 discloses a method for controlling a turn indicator of a motor vehicle when the turn indicator is not actuated by a driver, with a recognition device detecting that the driver intends a maneuver to change lanes or turn, and when the intention of the driver is determined, the turn indicator is activated.

Document DE 10 2017 206 605 A1 discloses a method for controlling a function of a vehicle, in which a traffic situation is determined in which the vehicle is currently present. Alternatively or in addition, the behavior of a driver of the vehicle and information about the specific traffic situation are evaluated and a turn indicator of the vehicle is set as a function of the result of the evaluation.

Document US 2012/0089300 A1 discloses a system for activating a turn indicator. If a navigation system detects that the vehicle is approaching a turn, the turn indicator can be automatically activated in the appropriate direction.

Generally, it is desirable to reliably determine an intention of a driver to turn even if the route is not known and/or navigation information is not available. In particular, incorrect turn indications should be safely avoided.

Based on the known state of the art, it is therefore an object of the invention to provide a device and a method for determining an intention of a driver to turn.

This problem is respectively solved by a device with the features of claim 1 and by a method with the features of the independent method claim. Advantageous further aspects are specified in the dependent claims.

With the device having the features of claim 1 a turn intention of a driver can be easily and reliably determined. On this basis, it can be verified whether a turn indicator, of a vehicle, i.e. a turn signal light, is correctly set. An incorrectly activated turn indicator can preferably be deactivated if no intention to turn has been determined. Alternatively or in addition, a message can be issued to the driver to activate the turn indicator and/or a turn indicator of the vehicle can be automatically activated. As a result, road safety can be increased.

The interior camera may be an interior camera integrated into the interior rearview mirror of the vehicle or integrated into the housing of the interior rear-view mirror, an interior camera arranged above the driver and/or the passenger in the roof area and/or in the A-pillar on the side of the driver and/or the passenger side. As a result, vehicle occupants can be detected easily and safely. It is also advantageous if the field of view of the interior camera has a capture angle in the range of 100° to 150°, the interior camera preferably being a monoocular camera and/or an RGB-IR camera. In particular, this allows image processing by the processing unit to take place based on the recorded IR images. Furthermore, there is a sufficiently large viewing area of the interior camera to detect the driver and to determine, based on the image data from the interior camera, whether or not there is an intention to turn as a result of the behavior of the driver.

It is advantageous if the processing unit is configured to verify whether at least one turning option for the vehicle is available in the visual capture area of the driver and whether this turning option is within the determined focus range in order to determine the first result. As a result, it can be reliably determined whether the focus of the driver on the focus area is associated with a turning option, in particular whether there is a road or driveway in the focus area. The focus may be determined in particular with the aid of a heat map.

It is further advantageous if the processing unit is configured to determine at least one possible turning direction of the vehicle in the visual capture area of the driver based on the environmental information provided by the environment capture unit and to verify the first result based thereon, the processing unit being configured to change the first result based on the result of the verification. The environment capture unit may be a lidar unit, a radar unit and/or a front camera, in particular a stereo front camera. In this case, the environment capture unit captures in particular the area in front of the vehicle and laterally in front of the vehicle and preferably produces a 3D image of the vehicle environment. This facilitates verifying whether there is even a possibility of turning in the focus area.

It is further advantageous if the processing unit is configured to verify whether safe turning is possible based on the odometry data in order to determine the second result. The odometry data of the vehicle include, in particular, steering angle, speed and/or acceleration (positive and negative acceleration). This facilitates verifying whether there is even a possibility of turning in the focus area.

It is further advantageous if the processing unit is configured to verify whether based on stored odometry data associated with the driver and/or the vehicle and the odometry data of the vehicle an intention of the driver to turn exists in order to determine the second result. As a result, an even more precise verification can be performed as to whether the intention of the driver of the vehicle to turn is possible or appears likely based on his usual driving behavior.

It is further advantageous if the processing unit is configured to verify whether there is a traffic-related reason for the odometry data in order to determine the third result. Such a traffic-related reason may be a preceding vehicle, a pedestrian crossing the road, the reaction of the driver to a stop sign or a yield sign, a speed limit or a traffic light indicating yellow or red. This ensures that other causes for determined odometry data can be considered or ruled out. As a result, the determination of the intention to turn can be further improved.

It is further advantageous if the processing unit is configured to determine a positive first result when a focus area outside the vehicle has been determined. The processing unit may further be configured to determine a positive first result only if the focus area is not only outside the vehicle, but in particular with a focus in the expected turning direction. As a result, the not directly relevant gazes of the driver in a straight line outside the vehicle may also be disregarded for the recognition of the turning intention when determining the first result. The processing unit may further be configured to determine a positive second result if the odometry data enable or do not preclude the vehicle from turning in the direction of the determined focus area. Furthermore, the processing unit may be configured to determine a positive third result if the determined odometry data have no other cause. The processing unit can only determine the intention to turn if all three results are positive. As a result, the intention of the driver of the vehicle to turn can be reliably determined.

The processing unit may also be configured to determine the probability of the existence of a turning intention-related focus area outside the vehicle as a first result, to determine the probability of the vehicle turning in the direction of the determined focus area based on the odometry data as a second result, and, as a third result, to determine the probability whether the determined odometry data have no other cause.

The processing unit may be configured to determine an overall probability, at least based on the three results, and to determine an intention to turn when the determined overall probability exceeds a preset stored limit value. It is further advantageous if three individual probabilities are each compared with a limit value and the overall result is determined from the results of the comparisons. In particular, a positive overall result can be determined if all individual probabilities are above the respective limit value. Alternatively, the overall result can be an overall probability, which is then in turn compared with a preset stored limit value in order to determine whether or not there is an intention to turn. All mentioned limit values can be defined on a driver-specific basis and in particular stored in the vehicle, in the vehicle key or in a cloud memory associated with the driver.

Furthermore, the processing unit may be configured to output information to the driver via an output unit of the vehicle to actuate the turn indicator and/or to activate the turn indicator automatically after a preset time if the driver does not abort. As a result, a correct turn indicator of the vehicle can be activated. This increases road safety.

The processing unit is preferably configured to determine the gaze direction of the driver and to determine the focus area based on gazes of the driver directed outside in order to determine the first result over a preset period of time of several seconds. In particular, a heat map is created based on the gazes or gaze directions and compared with at least one heat map of the driver, which was determined in a traffic situation in which the driver had no intention of turning.

When determining the focus area or determining the heat maps, gazes of the driver that are directed at vehicle interiors, such as instrument clusters, instrument panels, interior mirrors and exterior mirrors, are not considered or excluded. This allows focus areas and heat maps to be correctly determined.

In order to determine the first result, the processing unit may also be configured to detect a head-eye rotation of the driver over a preset period of several seconds and to determine the focus area based on the detected head-eye rotation. For example, an evaluation algorithm or an artificial neural network can be used to determine the head-eye rotation and/or the focus area. This facilitates reliably recognizing an intent to turn in different types of drivers.

In addition, the processing unit may be configured to determine an odometry pattern over a preset period of several seconds in order to determine the second result and to compare it with odometry patterns preferably stored for the driver and/or the vehicle. This facilitates verifying whether a driver actually intends to turn.

It is advantageous if the processing unit is configured to determine a possible turn direction (for example from map data or based on video analysis) to determine the second result and to verify the plausibility of the safe execution of a turn maneuver in the determined turn direction (for example with the aid of a determined curve radius and the speed of the vehicle). For this purpose, required driving intervals can be determined and the determined driving intervals can be determined with the current travel speed and direction data in order to verify the plausibility of the intention to turn. The plausible driving intervals required to safely perform a turning maneuver in the determined turn direction can also be determined and the possibility of performing the determined driving intervals can be verified with the current travel speed and direction data to verify the plausibility of the intention to turn. This facilitates verifying whether a driver actually intends to turn.

It is further advantageous if the processing unit is configured, in order to determine the third result, to verify whether objects, such as vehicles, people and/or immovable objects are located within the trajectory of the vehicle, which account for the current driving speed and direction data, and or whether a collision or approximation of the trajectories of the detected objects with the trajectory of the vehicle is predictable. If no collision or approach is predicted, the probability of the intention to turn can be increased or an intention to turn that has already been determined can be confirmed. This also facilitates verifying whether a driver actually intends to turn.

The intention to turn in the sense of this application may include, in addition to turning into a street or a driveway, an intention to change lanes or turn.

The method with the features of the secondary procedural claim has the same advantages as the claimed device. The method can be further developed with the same features as the device, in particular with the features of the dependent claims directed at the device.

Other objects, advantages and novel features of the present invention will become apparent from the following detailed description of one or more preferred embodiments when considered in conjunction with the accompanying drawings.

Exemplary embodiments of the invention are explained in more detail below with reference to the figures, which show:

### BRIEF DESCRIPTION OF THE DRAWINGS

FIG. 1 a perspective schematic illustration of a cockpit of a vehicle;

FIG. 2 a schematic illustration of a first image of the interior of the vehicle captured by the camera;

FIG. 3 the gaze direction of a driver in a schematic illustration; and

FIG. 4 a diagram with a heat map of the gaze direction of the driver according to FIG. 3;

FIG. 5 a diagram with a heat map of the accumulated gaze directions of the driver over a preset period of time of driving sections without the intention of turning;

FIG. 6 a diagram with a heat map of the accumulated gaze directions of the driver over a preset period of time during a further driving section;

FIG. 7 a diagram of a heat map showing the difference between the heat map according to FIG. 5 and the heat map according to FIG. 6; and

FIG. 8 a diagram of the heat map according to FIG. 7 with superimposed environmental data to determine turning options.

### DETAILED DESCRIPTION OF THE DRAWINGS

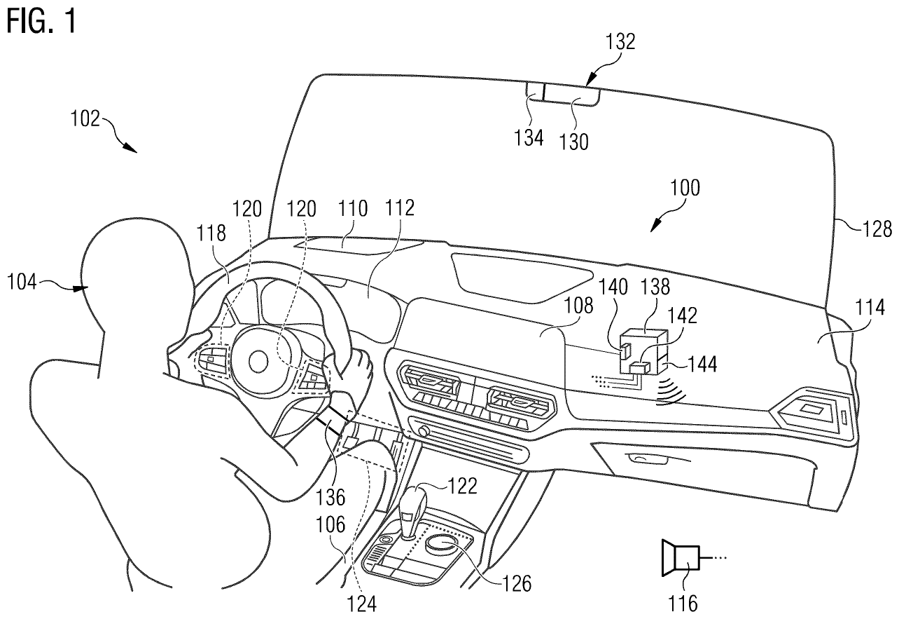

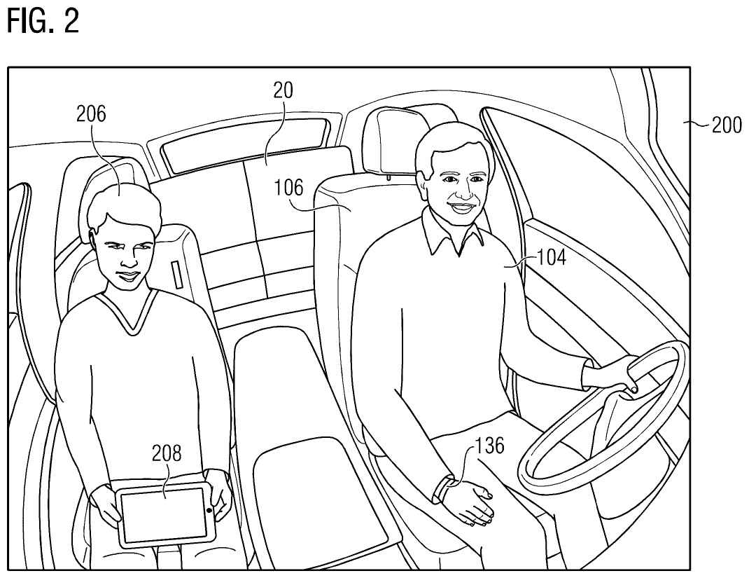

FIG. 1 shows a perspective schematic illustration of a cockpit 100 of a vehicle 102. A driver 104 is seated in a driver seat 106 of the vehicle 102. The cockpit 100 further comprises a central information display (CID) 108, a head-up display 110 and a graphical instrument cluster 112, which are arranged in a dashboard 114 of the vehicle 102. The aforementioned display elements 108, 110, 112 each form a functional unit of an output unit of the vehicle 102, which is configured to output information to the driver 104 and/or a further occupant 206 (cf. FIG. 2). At least one loudspeaker 116 of an entertainment system of the vehicle 102 is also arranged in the cockpit 100. The loudspeaker 116 further forms a functional unit of the output unit. The functional units of the output unit also serve as a playback unit for audio and/or video playback.

The cockpit 100 also comprises a steering wheel 118 with operating elements 120, a gear selector 122, pedals 124 and an input unit 126 with a rotary wheel and a push button function and/or a touch input field. This input unit 126 is also referred to as ergo commander.

An interior rearview mirror 132 and an interior camera 134 integrated into this interior rearview mirror 132 are arranged in the upper area of a windshield 128 of the vehicle 102. The interior camera 134 is configured and integrated into the rear-view mirror 132 in such a way that it captures images depicting at least one area of the interior of the vehicle 102. Specifically, the field of view of the interior camera 134 is directed in the direction of the driver seat 106 and a passenger seat 202 of the vehicle 102.

An example of an image 200 taken with the aid of the interior camera 134 is shown in FIG. 2. The interior camera 134 is in particular configured to capture a plurality of sequential images, in particular in the form of a video stream, to generate image data corresponding to the images 200 and to transmit this to a control unit 138 serving as a processing unit.

The control unit 138 comprises data outputs 140 and data inputs 142, which are used to connect to further units of the vehicle 102, for example with further cameras, sensors, input and output units, and control units of assistance systems.

The control unit 138 also comprises a communication module 144, which is configured to establish a connection to a telecommunications network, in particular a mobile communications network.

Furthermore, additional cameras may be arranged in the interior of the vehicle 102 in the A-pillars or above the driver 104. With the aid of the interior camera 134 and/or the other interior cameras, the gaze direction of the driver 104 while using the vehicle 102 may be determined.

FIG. 2 shows a schematic illustration of an image 200 of the interior of the vehicle 102 taken by the interior camera 134. The interior camera 134 has an exemplary field of view of 120 degrees. It is particularly advantageous if the camera 134 is an RGB-IR interior camera. In other embodiments, the interior camera 134 may also have a field of view in the range of 150 degrees or more. The interior camera 134 is oriented in the direction of the driver seat 106, a passenger seat 202 and a rear seat 204 of the vehicle 102. In the situation shown in FIG. 2, the driver 104 is sitting in the driver seat 106 and the other occupant 206 is sitting in the passenger seat 202. In the present embodiment, the other occupant 206 is therefore a passenger 206. In FIG. 2, the driver 104 is wearing a smart watch 136 and the passenger 206 is holding a tablet computer 208.

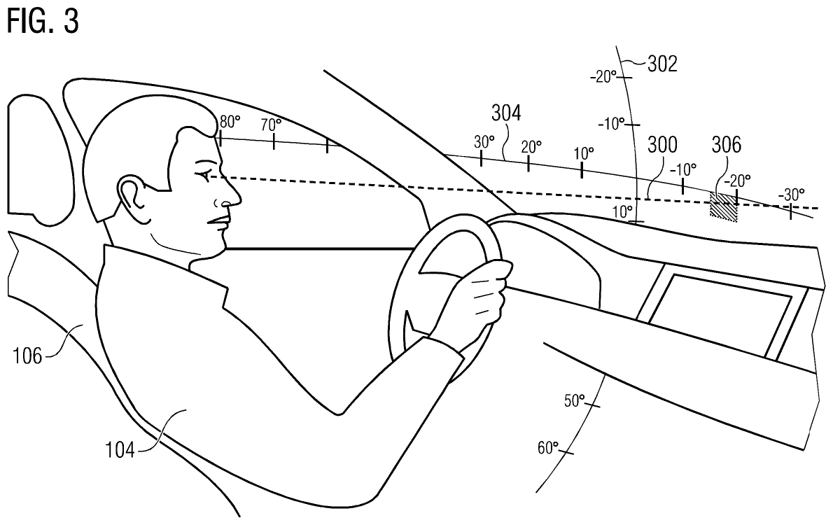

FIG. 3 shows a schematic illustration of the determination of the gaze direction of a driver 104 of the vehicle 102. For illustration, a scale of the horizontal rotation angle 302 and a scale of the vertical angle of rotation 304 are shown. The rotation angles 302, 304 may relate to a vehicle coordinate system of the vehicle 102. In the driving situation shown in FIG. 3, the gaze direction vector 300 of the driver 104 has a horizontal rotational angle 302 of −17.5 degrees and a vertical rotational angle 304 of +2.5 degrees. To generate a heat map, the coordinate system of the horizontal rotation angle 302 and the vertical rotation angle 304 is divided into gaze direction segments 306 measuring 5 degrees×5 degrees. The gaze direction vector 300 runs through the gaze direction segment 306.

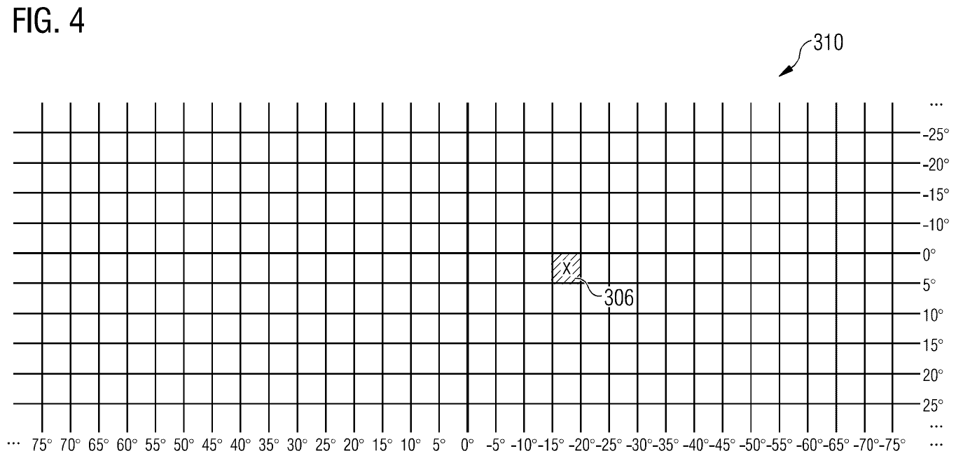

FIG. 4 shows a diagram with a heat map 310 of the gaze direction vector 300 determined from a single recorded image 200 of the interior camera 134, i.e. of the current gaze direction segment 306 of the driving situation according to FIG. 3.

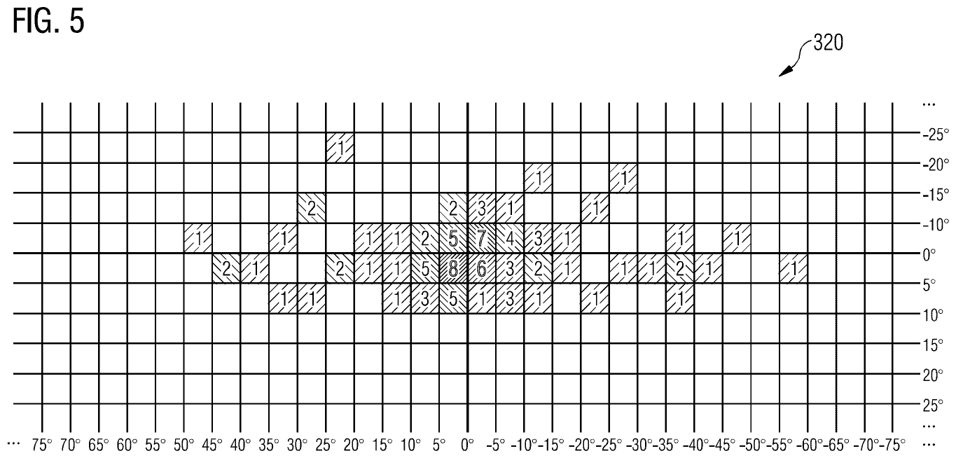

The gaze direction vector 300, with its two components of horizontal rotational angle 302 and vertical rotational angle 304 is captured in an accumulated manner over a specific long-term interval in the range of 5 minutes to 90 minutes during regular driving sections, i.e. without taking into account turning, lane changing or turning maneuvers. As a result, the individual “normal behavior” of the driver 104 is determined. This is shown in the diagram shown in FIG. 5 with the heat map 320 of the accumulated gaze directions 300 of the driver 104 over a preset period of 90 minutes for travel sections without the intention of turning. Such a heat map 320 is also referred to as a long-term heat map. The figures in the heat map 320 and in the heat maps of the following figures show the presence of the gaze vector 300 in the corresponding gaze direction segment 306 in percent. The heat maps 310, 320 and the heat maps of the other figures are resolved with an angle increment of 5°. In other embodiments, larger or smaller angle increments may be used.

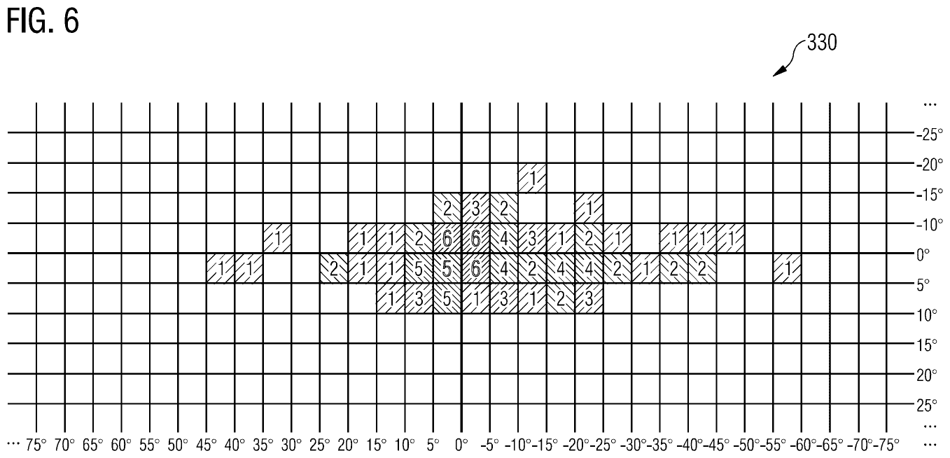

FIG. 6 shows a diagram with a heat map 330 of the accumulated gaze directions of the driver 104 over a short preset period of time in the range of 2 seconds to 60 seconds, in particular of 5 seconds, during a further driving segment. During this further driving segment, it should be verified whether the driver 104 currently intends to turn or not. The heat map 330 is therefore a short-term heat map 330 of the current driving situation. It is also known as the short term heat map 330. During this further driving segment, it should be verified whether the driver is intending to turn.

The intention to turn in the sense of this application may include, in addition to turning into a street or a driveway, an intention to change lanes or turn.

The short term heat map 330 is generated in the same manner as the long term heat map 320, which serves as a reference without taking into account the gazes of the driver 104 into the center and side mirrors and into the other interior of the vehicle. For example, only the segments of the horizontal rotational angle 302 in the range of −15 degrees to −25 degrees and the vertical rotational angle in the range of 0 degrees to 5 degrees are considered in the evaluation. In other embodiments, the other areas/viewing angle segments cannot be captured or cannot be considered when creating the heat map 310 to 330.

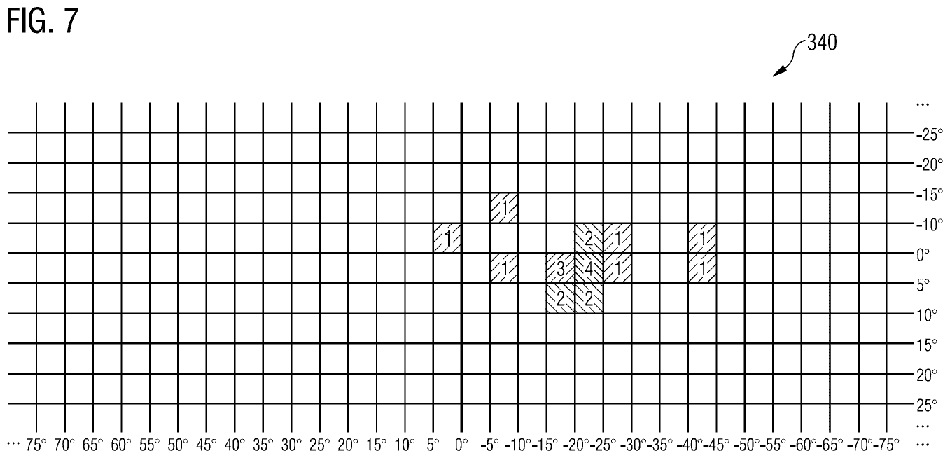

FIG. 7 shows a diagram with a difference heat map 340, which was determined from the difference between the heat map 330 according to FIG. 6 and the heat map 320 according to FIG. 5, when the corresponding value in the heat map 330 is greater than the value in the heat map 320.

The difference heat map 340 can be calculated as follows:

If the value of an image segment SEGst (h, v)>the value of the image segment SEGIt(h, v), then the value of the image segment is SEGd(h, v)=SEGst(h, v)−SEGIt(h, v), otherwise the value of the image segment is segD(h, v)=0, wherein
SEGst=value of the image segment at the position h (horizontal) and v (vertical) of the short term heat map 330
SEGIt—value of the image segment at the position h (horizontal) and v (vertical) of the long term heat map 320
SEGd—value of the image segment at position h (horizontal) and v (vertical) of the difference heat map 340

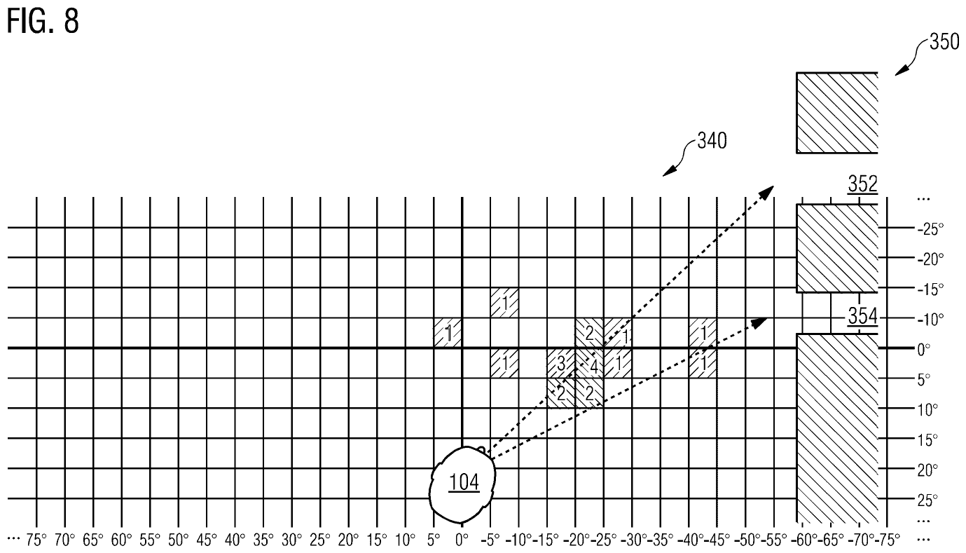

The difference heat map 340 therefore indicates the focus area of the driver 104 that is relevant for an intention to turn. The image segments SEGd (h, v) of the difference heat map 340 can then be mapped onto the environment in order to determine the most probable turning option. The mapping requires compensation for the movement of the vehicle 102 itself (ego movement). For a simple illustration, a diagram with the difference heat map 340 according to FIG. 7 with superimposed environmental data for determining turning options in a snapshot is shown in FIG. 8. The superposition of the difference heat map 340 with the environment has been carried out using 2D map data 350. In other embodiments, 3D map data or 2D or 3D camera data from a front camera or the environmental information provided by another environment capture unit (lidar, radar) of the vehicle 102 can also be used for superposition.

From the map data and/or the front camera data and/or the sensor data of an environment capture unit, all available turning options in the field of view of the driver are determined. In the exemplary embodiment according to FIG. 8, the side road 352 and the side road 354 have been identified as turning options. For each determined turning option 352, 354, a turn probability is determined based on the segmentation and weighting of the focus points in the difference heat map 340. For example, the probability of turning into the side street 354 is 10% and the turn probability of the turning option into the side road 352 is 75% calculated as the first result.

Based on odometry data from the vehicle 102, the control unit 138 determines the possibility of the vehicle 102 turning in the direction of the determined focus area as a second result.

Furthermore, based on environmental information provided by an environment capture unit, the control unit 138 verifies whether the odometry data enabling a turn have another cause and determines the result of the verification as a third result.

Based on the three results obtained, the control unit 138 determines whether the driver 104 intends to turn or not. Based thereon, a turn indicator of the vehicle 102 can be activated automatically or a message is output to the driver 104 to activate the turn indicator.

In addition, when the turn indicator is activated automatically in the traffic situation shown in FIG. 8 with two nearby turning options 352, 354 in the same direction, the time for activation can be selected so that the turn indicator is automatically set to indicate turning into the side road 352 at the earliest shortly after the vehicle has passed the side road 354. This way, safety can be increased by avoiding dangerous situations. For example, if there is a turn in the side road 352, activation of the turn indicator in front of the side road 354 could result in vehicles coming from the side road 354 mistakenly recognizing a turn intention of the vehicle 102 and driving into the road in which the vehicle 102 is located.

The processing steps described above, in particular the steps for processing the image data and generating the heat maps, are performed by the control unit 138 serving as a processing unit.

In the exemplary embodiments described with reference to FIGS. 1 to 8, at least the interior camera 134 and the control unit 138 form a device for determining a turn intention of the driver 104 of a vehicle 102. Other elements and features shown in FIGS. 1 to 8 and mentioned in the preceding description may be part of the device for determining a turn intention of the driver 104 of a vehicle 102. Process steps described using the device may also be part of the claimed method.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

### LIST OF REFERENCE SIGNS

100 Cockpit
102 vehicle
104 drivers
106 driver seat
108 central information display
110 Head Up Display
112 graphical instrument cluster
114 dashboard
116 speakers
118 steering wheel
120 control element
122 gear selector
124 pedals
126 input unit
128 windscreen
130 microphone
132 interior rearview mirror
134 interior camera
136 smart watch
138 control unit
140 data output
142 Data input
144 communication interfaces
200 image
202 passenger seat
204 back seat
206 passengers
208 tablet computers
300 gaze direction vector
302 scale horizontal rotation angle
304 scale vertical rotation angle
310, 320, 330, 340 Heat map
350 card data
352, 354 side street

What is claimed is:

1. A device for determining an intention of a driver of a vehicle to turn, the device comprising:
an vehicle interior camera configured to capture at least one image sequence and generate image data corresponding to each image of the sequence, wherein each image of the sequence depicts an area of the vehicle interior;
a processing unit configured to process the image data, wherein the processing unit is configured to determine:
a first result, based on the image data, wherein the first result is a focus area of a driver outside the vehicle,
a second result, based on odometry data from the vehicle, wherein the second result is the possibility of the vehicle turning in the direction of the determined focus area,
a third result, via an environmental capture unit, wherein the third result verifies whether odometry data enabling a turn has another cause, and
determine an intention to turn based on the three results obtained.

2. The device according to claim 1, wherein the processing unit is configured to verify, in order to determine the first result, whether at least one turning option of the vehicle exists in the visual capture area of the driver and whether this turning option is within the determined focus area.

3. The device according to claim 1, wherein the processing unit is configured to determine at least one possible turning direction of the vehicle in the visual capture area of the driver based on the environmental information of the visual capture area of the vehicle provided by the environment capture unit and to verify the first result based thereon, wherein the processing unit is configured to change the first result based on the result of the verification.

4. The device according to claim 1, wherein the processing unit is configured to verify whether safe turning is possible based on odometry data from the vehicle in order to determine the second result.

5. The device according to claim 1, wherein the processing unit is configured to verify whether, based on stored odometry data associated with the driver and/or the vehicle and the odometry data of the vehicle, an intention of turning of the driver is probable in order to determine the second result.

6. The device according to claim 1, wherein the processing unit is configured to verify whether there is a traffic-related reason for the odometry data of the vehicle in order to determine the third result.

7. The device according to claim 1, wherein the processing unit is further configured to determine:
a positive first result if the focus area exists outside the vehicle in a specific turning direction,
a positive second result if the odometry data allow the vehicle to turn in the direction of the determined focus area,
a positive third result if the determined odometry data have no other cause, and
the intention to turn only when all three results are positive.

8. The device according to claim 1, wherein the processing unit is further configured to determine:
as a first result, the probability of the existence of a focus area contingent on an intention to turn outside the vehicle,
as a second result, the probability of the vehicle turning in the direction of the determined focus area based on the odometry data,
an overall probability, at least based on the three results, and
an intention to turn when the determined overall probability exceeds a preset stored limit value.

9. The device according to claim 1, wherein the processing unit is configured to:
output information to the driver via an output unit of the vehicle,
actuate the turn indicator automatically after a preset time if the driver does not abort.

10. The device according to claim 1, wherein the processing unit is configured to detect the gaze direction of the driver over a preset period of time of several seconds in order to determine the first result and to determine the focus area based on the gazes of the driver directed outside the vehicle.

11. The device according to claim 1, wherein the processing unit is configured to detect a head-eye rotation of the driver over a preset period of several seconds in order to determine the first result and to determine the focus area based on the detected head-eye rotation.

12. The device according to claim 1, wherein the processing unit is configured to determine an odometry pattern over a preset period of several seconds in order to determine the second result and preferably to compare it with odometry patterns stored for the driver and/or the vehicle.

13. The device according to claim 1, wherein the processing unit is configured to:
determine a possible turning direction in order to determine the second result,
determine the plausible driving intervals required to safely perform a turning maneuver in the determined turning direction, and
verify the possibility of performing the determined driving intervals with the current driving speed data and direction data in order to render the turn intention plausible.

14. The device according to claim 1, wherein the processing unit is configured to verify whether there are objects in the vehicle trajectory which account for the current travel speed data and direction data, and/or whether a collision or convergence of the trajectories of the detected objects with the vehicle trajectory is predictable.

15. A method for determining an intention of a driver to turn, the method comprising:
capturing at least one sequence of images via a vehicle interior camera, wherein each image of the sequence depicts an area of the interior;
generating image data corresponding to each image;
processing the image data, via a processing unit, so as to determine:
a first result based on the image data, wherein the first result is a focus area of a driver outside the vehicle,
a second result based on odometry data from the vehicle, wherein the second result is the possibility of the vehicle turning in the direction of the determined focus area,
a third result based on data from an environment capture unit, wherein the third result verifies whether the odometry data enabling a turn has another cause, and
an intention to turn based on the three obtained results.
